(19) United States
(12) Patent Application Publication
(10) Pub. No.: US 2026/0355709 A1
(43) Pub. Date: Nov. 12, 2026

(54) COLOR MIXING DEVICE

(71) Applicant: ZHENGZHOU SANHUA TECHNOLOGY & INDUSTRY CO., LTD., Zhengzhou City (CN)

(72) Inventors: Kunkun Zhang, Zhengzhou City (CN); Jianhua Yu, Zhengzhou City (CN)

(21) Appl. No.: 19/672,796

(22) Filed: May 11, 2026

(30) Foreign Application Priority Data
May 12, 2025 (CN) 202510607648.3
May 12, 2025 (CN) 202520926760.9
May 12, 2025 (CN) 202520926787.8
May 12, 2025 (CN) 202520927745.6
May 12, 2025 (CN) 202520927761.5

(51) Int. Cl. B01F 35/45; B01F 27/90; B01F 35/33; B01F 35/71; B01F 101/30

(52) U.S. Cl. CPC B01F 35/45; B01F 27/90; B01F 35/33; B01F 35/7176; B01F 2101/30

(57) ABSTRACT

The present disclosure relates to the field of refinish paints and provides a color mixing device. According to the color mixing device provided by the present disclosure, the color mixing device is communicated with the injection mechanism through the injection path. When the color mixing device is in the working state, the color mixing device can be directly mounted to the color paint raw material bucket, thereby ensuring that the color paste is transported from the injection path to the injection mechanism and then discharged, without the need to transfer the color paste in the color paint raw material bucket to another specially designed container.

### CROSS-REFERENCE TO RELATED APPLICATION

The present disclosure claims priority to Chinese patent Application No. 2025106076483, filed with the Chinese Patent Office on May 12, 2025, titled “COLOR MIXING DEVICE”; Chinese Patent Application No. 2025209277615, filed with the Chinese Patent Office on May 12, 2025, titled “INJECTION DEVICE AND COLOR MIXING DEVICE”; Chinese Patent Application No. 2025209277456, filed with the Chinese Patent Office on May 12, 2025, titled “STIRRING MECHANISM AND COLOR MIXING DEVICE”; Chinese Patent Application No. 2025209267878, filed with the Chinese Patent Office on May 12, 2025, titled “COLOR PAINT BUCKET STIRRING SLURRY COVER AND PAINT MIXING STIRRING APPARATUS”; and Chinese Patent Application No. 2025209267609, filed with the Chinese Patent Office on May 12, 2025, titled “PAINT BUCKET SLURRY COVER PAINT INJECTION DEVICE”, the entire contents of which are incorporated by reference into the present disclosure.

### TECHNICAL FIELD

The present disclosure relates to the technical field of paint mixing devices, particularly to a color mixing device.

### BACKGROUND ART

In paint mixing, coating preparation, or related industrial applications, a paint mixing stirrer is a commonly used device in fields such as decorative paints (architectural coatings) and automotive refinishing (industrial coating production lines or household paint mixing). The slurry cover used for a color paint bucket, i.e., the “paint mixing slurry cover”, generally refers to a lid of a paint mixing container (such as a mixing bucket or a stirring tank), and its function is tightly related to characteristics of the paint mixing process.

The paint mixing slurry cover can reduce the volatilization of solvents inside the paint mixing container, thereby avoiding material waste (loss of active components), environmental pollution (volatile organic compounds VOCs emissions), and presence of safety hazards (accumulation of flammable and explosive gases). Meanwhile, it also serves a dust-proof and anti-contamination function. Since the paint mixing requires high cleanliness, the slurry cover can prevent dust and impurities from falling into the paint liquid, thereby avoiding particles and defects on the sprayed paint surface, and preventing color differences caused by foreign matter contaminating the color paste or additives. In addition, a sealed environment ensures a stable ratio of solvent to solid content in the paint by reducing solvent evaporation, thereby preventing degradation of paint film performance (such as adhesion and gloss) caused by volatilization.

However, when using the existing slurry covers of the color paint bucket, the color paste needs to be transferred from the color paint raw material bucket of the manufacturer into a masterbatch bucket (i.e., a traditional slurry cover provided with an original container), which makes it impossible to use a color mixer for automatic paint mixing. If automatic paint mixing by the color mixer is required, the paint needs to be added to a device-dedicated color paste bucket. This necessary step introduces an additional preparation process of transferring the color paste raw material during paint mixing. Moreover, the device-specific color paste bucket, being a large component, increases the complexity of the device used during the paint mixing process. This type of paint mixing slurry cover provided with the masterbatch bucket includes a device-dedicated color paste bucket and a pump-valve assembly fixedly connected thereto. Since each type of color paste raw material corresponds to one masterbatch bucket, a single color mixer needs to be provided with multiple groups of paint mixing slurry covers each having a masterbatch bucket, which further increases the raw material cost and manufacturing cost of the device.

### SUMMARY

In view of this, the present disclosure provides a color mixing device to solve the above technical problems to a certain extent.

According to the present disclosure, a color mixing device is provided, including:
a cover member, wherein the cover member includes a first side part and a second side part opposite to each other, and the first side part is configured to face a color paint raw material bucket to cover the color paint raw material bucket;
an injection path, wherein the injection path includes a first path extending from the first side part in a direction away from the cover member and a second path extending along the first side part; and
an injection mechanism, wherein the injection mechanism is connected to the cover member, and the injection mechanism is in communication with the second path.

Based on the above technical solution, optionally, the color mixing device further includes a stirring mechanism; the stirring mechanism includes a rotating assembly;
the rotating assembly is sleeved on an outer side of the first path; and
the rotating assembly can rotate around the first path to stir materials in the color paint raw material bucket.

Based on any one of the above technical solutions, optionally, the color mixing device further includes a stirring mechanism; the stirring mechanism is connected to the cover member; and the stirring mechanism is configured to stir materials in the color paint raw material bucket; the stirring mechanism includes a driving assembly and a rotating assembly; the rotating assembly is configured to stir the materials in the color paint raw material bucket; the driving assembly passes through the second path; and the driving assembly is in transmission connection with the rotating assembly.

Based on any one of the above technical solutions, optionally, the injection path further includes a third path; the first path, the second path, and the third path are sequentially communicated; the third path is configured to be located on an outer side of the color paint raw material bucket when the cover member is covered on the color paint raw material bucket, and the injection mechanism is communicated with the second path via the third path; and
the driving assembly includes a driving shaft and a driving gear passing through the second path; the rotating assembly includes a rotating body that can rotate around the first path; and the driving gear is in a transmission connection with the rotating body.

Based on any one of the above technical solutions, optionally, the color mixing device further includes a stirring mechanism connected to the cover member, and the stirring mechanism further includes a rotating assembly configured to stir materials in the color paint raw material bucket;
the rotating assembly includes a rotating body and multiple blades located at an outer side of the rotating body, and the rotating body can rotate around the first path; and
the rotating body has multiple side surfaces distributed sequentially in a circumferential direction.

Based on any one of the above technical solutions, optionally, the color mixing device further includes a stirring mechanism connected to the cover member, and the stirring mechanism further includes a rotating assembly configured to stir materials in the color paint raw material bucket; and
the rotating assembly includes a rotating body;
the rotating assembly can rotate around the first path;
the rotating body has a cavity; and
an inner side part of the cavity is arranged at intervals from an outer side part of the first path.

Based on any one of the above technical solutions, optionally, the rotating body has multiple through holes, and each through hole is communicated with the cavity and an environment where the rotating body is located.

Based on any one of the above technical solutions, optionally, the rotating body has multiple side surfaces distributed sequentially in the circumferential direction; each of the side surfaces is provided with at least one through hole; and the through holes on the adjacent side surfaces are alternately arranged in an opposite direction of the first side part and the second side part.

Based on any one of the above technical solutions, optionally, the injection mechanism includes a pump and a liquid outlet, and the pump extracts the materials in the color paint raw material bucket via the injection path and then discharges the materials via the liquid outlet; and the cover member has a slurry outlet;
the color mixing device further includes a cover plate and a wrench that is in transmission connection to the cover plate; and the wrench swings to drive the cover plate to cover and expose the slurry outlet; and
the wrench and the pump are located on a same side of the cover member.

Based on any one of the above technical solutions, optionally, the color mixing device further includes at least three clamping jaws in a same extension direction as the first path; and
the at least three clamping jaws are connected to the cover member; and
each of the clamping jaws has an inclined surface facing the color paint raw material bucket, and one side of the inclined surface close to the cover member is closer to the color paint raw material bucket than one side of the inclined surface farther from the cover member.

Based on any one of the above technical solutions, optionally, the color mixing device further includes a pressing mechanism;
the pressing mechanism includes a pressing rod passing through the cover member in an opposite direction of the first side part and the second side part;
the pressing mechanism further includes a cam lifting handle and a cam seat;
an upper end of the pressing rod is hinged to the cam lifting handle; and
the cam seat is sleeved on an outer side of the pressing rod; and
the cam lifting handle has a cam surface;
the cam seat is in contact with the cam surface;
the cam seat has a flange;
the pressing mechanism further includes a pressing spring;
one end of the pressing spring abuts against the flange; and
the other end of the pressing spring applies force to the pressing rod.

Based on any one of the above technical solutions, optionally, the injection path further includes a third path; the first path, the second path, and the third path are sequentially communicated; the third path is configured to be located on an outer side of the color paint raw material bucket when the cover member is covered on the color paint raw material bucket.

Based on any one of the above technical solutions, optionally, the cover member has a chamber located inside the cover member, and the second path is located in the chamber.

Based on any one of the above technical solutions, optionally, part of the first path and part of the third path are located in the chamber.

Based on any one of the above technical solutions, optionally, the color mixing device further includes a bracket base plate; the bracket base plate has a space passage passing through the bracket base plate in a direction opposite to each other along the first side part and the second side part; and the space passage is configured for the color paint raw material bucket to pass through.

Based on any one of the above technical solutions, optionally, the injection mechanism includes a pump and a liquid outlet, and the pump extracts the materials in the color paint raw material bucket via the injection path and then discharges the materials via the liquid outlet; and
the color mixing device further includes a pump bracket, wherein the pump is connected to the pump bracket, and the pump bracket is arranged on the bracket base plate.

Based on any one of the above technical solutions, optionally, the color mixing device further includes a first breathing valve and a second breathing valve, and both the first breathing valve and the second breathing valve pass through the cover member, wherein the first breathing valve conducts unidirectionally from the first side part to the second side part, and the second breathing valve conducts unidirectionally from the second side part to the first side part.

Based on any one of the above technical solutions, optionally, the injection mechanism includes a pump and a liquid outlet, and the pump extracts the materials in the color paint raw material bucket via the injection path and then discharges the materials via the liquid outlet;
the cover member has a slurry outlet; the color mixing device further includes a cover plate and a wrench in transmission connection with the cover plate; and the wrench swings to drive the cover plate to cover and expose the slurry outlet; and
the wrench and the pump are located on a same side of the cover member.

Based on any one of the above technical solutions, optionally, the rotating body has a stirring column; the stirring column extends along a first direction; the stirring column rotates around an axis extending along the first direction; the axis passes through the stirring column; and the stirring column has multiple side surfaces arranged sequentially adjacent in the circumferential direction, wherein the stirring column has a cavity.

Based on any one of the above technical solutions, optionally, each of the blades is connected to at least two of the side surfaces.

Based on any one of the above technical solutions, optionally, the stirring column further includes multiple through holes; each of the side surfaces is provided with at least one through hole; through holes on the adjacent side surfaces are alternately arranged in the first direction; the multiple through holes are all communicated with the cavity; and each of the through holes extends in the first direction.

Based on any one of the above technical solutions, optionally, the stirring mechanism further includes a driving assembly, and the rotating body further includes a shaft sleeve, wherein the shaft sleeve is connected to the stirring column;
the shaft sleeve is located on one side of the stirring column in the first direction;
the shaft sleeve is in transmission connection with the driving assembly; and
the driving assembly drives the shaft sleeve and the stirring column to rotate around the axis;
the cavity is in communication with the shaft sleeve;
one side of the cavity away from the shaft sleeve is opened; and
the cavity and the shaft sleeve jointly provide a path for a color paste to pass through;
one side of the rotating body away from the shaft sleeve has an opening, and the opening is communicated with the cavity; and
the shaft sleeve is detachably connected to the stirring column, or the shaft sleeve is integrally formed with the stirring column.

Based on any one of the above technical solutions, optionally, the cover member includes a slurry cover body;
the slurry cover body is mounted on a paint bucket; the slurry cover body has a fixing part, an adjustment part; and
a slurry outlet communicated with the color paint bucket, wherein the adjustment part can slide relative to the fixing part to open or close the slurry outlet; and the color mixing device further includes:
   a wrench member, arranged vertically, wherein one end of the wrench member is formed as a mounting part rotatably connected to the fixing part, and the other end is formed as a driving part located above the slurry cover body; and
   an elastic member, having a connecting part and an elastic part, wherein the elastic part is arranged between the wrench member and the fixing part, and the connecting part is respectively connected to the adjustment part and the wrench member;
   pressing the driving part causes the wrench member to rotate in a direction away from the fixing part and compress the elastic part, and the connecting part drives the adjustment part to move in a direction close to the fixing part, so as to open the slurry outlet; and
   releasing the driving part allows the elastic part to reset, thereby driving the wrench member to rotate toward a direction close to the fixing part, so that the connecting part drives the adjustment part to close the slurry outlet.

Based on any one of the above technical solutions, optionally, the wrench member is formed as a bar-shaped structure that is angled to a sliding direction of the adjustment part.

Based on any one of the above technical solutions, optionally, a protruding positioning part is formed on a side wall of the wrench member; and the elastic part is wound around a circumferential side wall of the positioning part, and one end of the elastic part away from the connecting part abuts against the fixing part.

Based on any one of the above technical solutions, optionally, the connecting part is formed as a U-shaped structure with an opening facing the driving part.

Based on any one of the above technical solutions, optionally, the adjustment part is provided with a convex part extending towards the connecting part, and the convex part is provided with a snapping groove for the connecting part to extend into.

Based on any one of the above technical solutions, optionally, the driving part is formed as a curved rod-shaped structure, and the driving part bends towards a direction close to the adjustment part.

Based on any one of the above technical solutions, optionally, it further includes:
a pump body, communicated with an interior of the color paint bucket and arranged on an outlet side of the color paint bucket, wherein the pump body is arranged on one side of the fixing part away from the adjustment part, so that the driving part can move in a direction close to or away from the pump body when the wrench member rotates.

Based on any one of the above technical solutions, optionally, at least part of the pump body is located above the slurry cover body to form a handle, and the handle and the driving part are arranged at intervals in the sliding direction of the adjustment part.

Based on any one of the above technical solutions, optionally, it further includes:
a fixing seat, mounted on the fixing part and hinged to the mounting part; and/or
a pressing assembly, including a supporting member and a pressing member, wherein the supporting member is mounted on a side of the fixing part and is provided with a mounting hole, and the pressing member passes through the mounting hole and abuts against one side of the connecting part facing away from the slurry cover body.

Based on any one of the above technical solutions, optionally, the cover member includes a slurry cover body, and a mounting chamber is formed inside the slurry cover body; and
the color mixing device further includes:
   a first transmission member, wherein one end can extend into the color paint bucket and connect to the rotating body, and the other end of the first transmission member is provided with a first gear; and
   a second transmission member, wherein the second transmission member is arranged non-coaxially with the first transmission member;
   one end of the second transmission member is provided with a second gear engaged with the first gear;
   the first gear and the second gear are arranged in the mounting chamber;
   the other end of the second transmission member is formed as a driving end extending outside the slurry cover body; and
   the driving end is connected to a power device that drives the rotating body to rotate.

Based on any one of the above technical solutions, optionally, the driving end is a bevel gear; the first gear and the second gear are cylindrical gears; an axis of the first transmission member is collinear with a center axis of the color paint bucket; and the first transmission member and the second transmission member are arranged parallel to each other.

Based on any one of the above technical solutions, optionally, it further includes:
a fluid pipeline, mounted on the slurry cover body, wherein one end of the fluid pipeline extends into the color paint bucket, and the other end is communicated with an outside of the color paint bucket; the first transmission member is formed as a shaft sleeve structure, so that an interior of the first transmission member is hollow; and
fluid pipeline passes through the interior of the first transmission member;
a first sealing member, arranged between an outer wall of the first transmission member and a chamber wall of the mounting chamber;
a second sealing member, arranged between an inner wall of the first transmission member and an outer wall of the fluid pipeline; and
a third sealing member, arranged between the fluid pipeline and the chamber wall of the mounting chamber.

In order to make the above purposes, features, and advantages of the present disclosure more obvious and easier to understand, the following is a detailed description of preferred embodiments in conjunction with the drawings.

### BRIEF DESCRIPTION OF DRAWINGS

In order to more clearly illustrate the technical solutions in the embodiments of the present disclosure, the drawings to be used in the embodiments of the present disclosure will be briefly introduced below. It should be understood that the following drawings only show certain embodiments of the present disclosure, and therefore should not be regarded as a limitation of the scope.

FIG. 1 is a three-dimensional schematic diagram of a paint bucket after being assembled to a color mixing device provided by an embodiment of the present disclosure;

FIG. 2 is a schematic diagram of FIG. 1 from a bottom-up perspective;

FIG. 3 is a three-dimensional schematic diagram of FIG. 1 from a right-rear perspective;

FIG. 4 is a schematic diagram of FIG. 1 from a left-side perspective;

FIG. 5 is another three-dimensional schematic diagram of FIG. 1;

FIG. 6 is a three-dimensional schematic diagram of a color mixing device provided by an embodiment of the present disclosure;

FIG. 7 is a schematic diagram of FIG. 6 from a lower-left perspective;

FIG. 8 is a sectional diagram of a color mixing device obtained by cutting along a vertical plane passing through a stirring main shaft provided by an embodiment of the present disclosure;

FIG. 9 is a three-dimensional schematic diagram of a color mixing device after omitting a pump and a valve provided by an embodiment of the present disclosure;

FIG. 10 is a schematic diagram of FIG. 9 from a bottom-up perspective;

FIG. 11 is a sectional structure schematic diagram of FIG. 9;

FIG. 12 is a schematic diagram of FIG. 9 from another bottom-up perspective;

FIG. 13 is a sectional structure schematic diagram of FIG. 9 from a left-to-right perspective;

FIG. 14 is a structure schematic diagram of a slurry cover of a color mixing device provided by an embodiment of the present disclosure;

FIG. 15 is an assembly structure schematic diagram of a slurry cover and a paint bucket of a color mixing device provided by an embodiment of the present disclosure;

FIG. 16 is an assembly structure schematic diagram of a slurry cover and a paint bucket of a color mixing device from another perspective provided by an embodiment of the present disclosure;

FIG. 17 is an assembly structure schematic diagram of a slurry cover and a paint bucket of a color mixing device from another perspective provided by an embodiment of the present disclosure;

FIG. 18 is an assembly structure schematic diagram of a color mixing device provided by an embodiment of the present disclosure;

FIG. 19 is a structure schematic diagram of a color mixing device with a slurry cover body after being cut provided by an embodiment of the present disclosure;

FIG. 20 is a sectional structure schematic diagram of a slurry cover of a color mixing device provided by an embodiment of the present disclosure; and

FIG. 21 is a sectional structure schematic diagram of a slurry cover of a color mixing device from another perspective provided by an embodiment of the present disclosure.

### DETAILED DESCRIPTION OF EMBODIMENTS

The technical solutions in the embodiments of the present disclosure will be clearly and completely described below in conjunction with the drawings in the embodiments of the present disclosure. It is obvious that the embodiments described are partial embodiments of the present disclosure, and not all of the embodiments. Based on the embodiments in the present disclosure, all other embodiments obtained by a person of ordinary skill in the art without inventive efforts shall fall within the scope of protection of the present disclosure.

In the description of the present disclosure, it is to be noted that orientation or positional relationships indicated by terms, such as “center”, “up”, “down”, “left”, “right”, “vertical”, “horizontal”, “inside”, “outside”, are the orientation or positional relationships based on the drawings, which are only to facilitate the description of the present disclosure and simplify the description, and are not to indicate or imply that the device or element referred to must have a particular orientation, or be constructed and operated with a particular orientation, and are not to be understood as limitations of the present disclosure. Additionally, the terms “first”, “second”, and “third”, etc., are used only for descriptions, and are not to be understood as indicating or implying a relative importance.

In the description of the present disclosure, it should be noted that unless other expressly specifications and limitations, the terms “mount”, “connect”, and “link” are to be understood in a broad sense, e.g. it can be a fixed connection, a detachable connection, or an integral connection; it can be a mechanical connection or an electrical connection; and it can be a direct connection, an indirect connection through an intermediate medium, or a communication inside two components. For a person of ordinary skill in the art, the specific meaning of the above terms in the present disclosure can be understood according to specific situations.

Additionally, the technical solutions between the various embodiments can be combined with each other, but it must be based on the fact that it can be realized by a person of ordinary skill in the art. When the combination of technical solutions is found to be contradictory or impossible to achieve, it should be considered that the combination of technical solutions does not exist, and is not within the scope of protection claimed by the present disclosure.

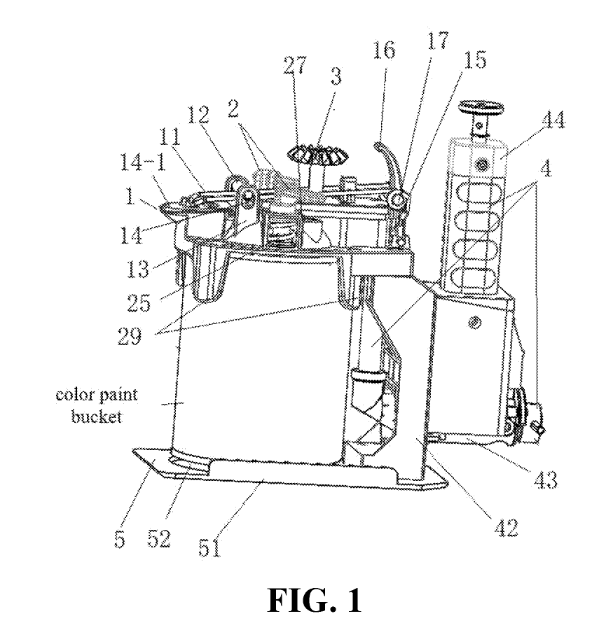

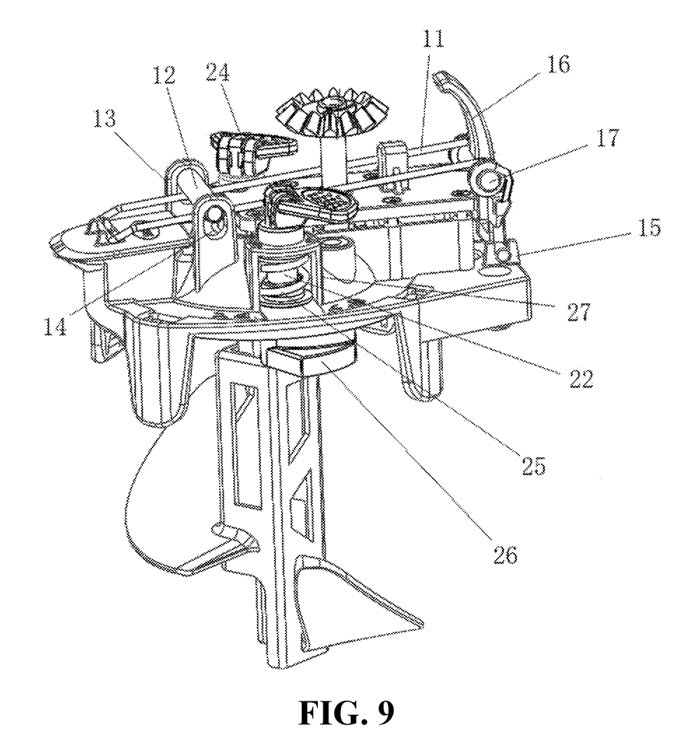

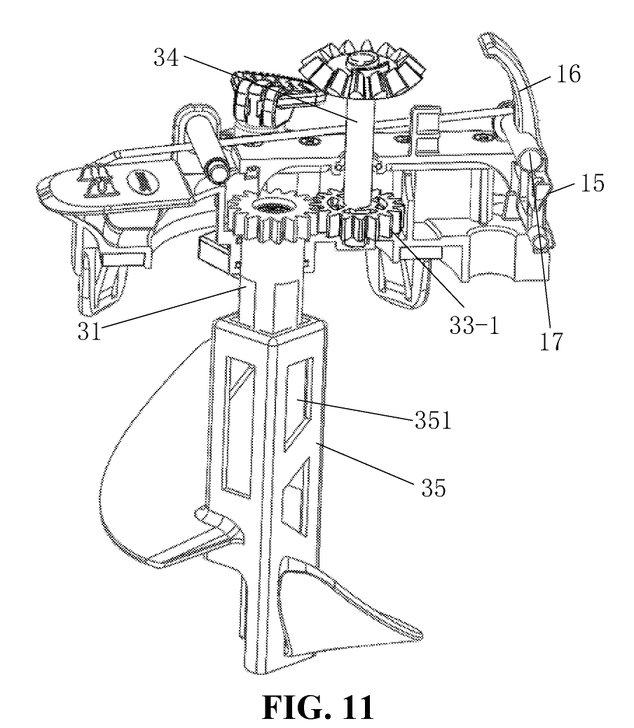

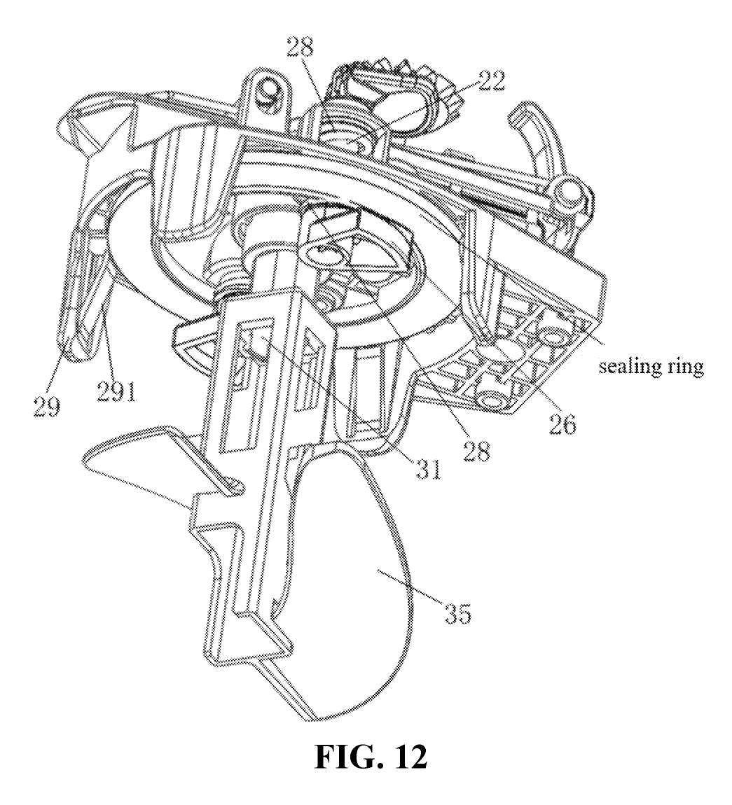

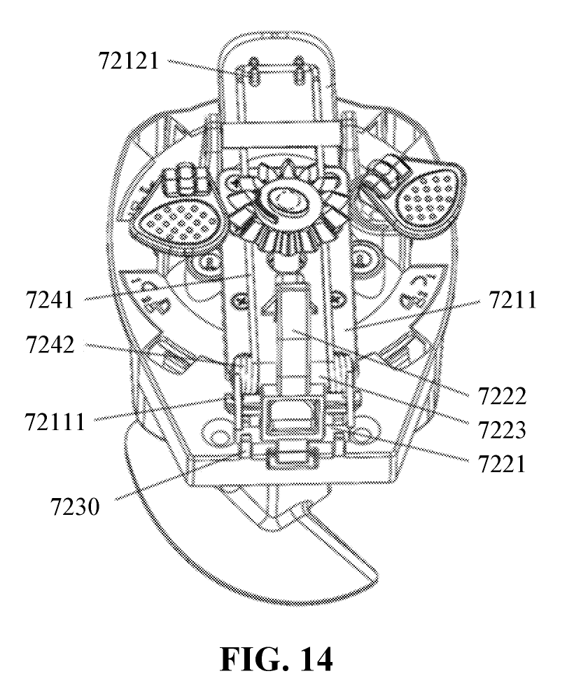

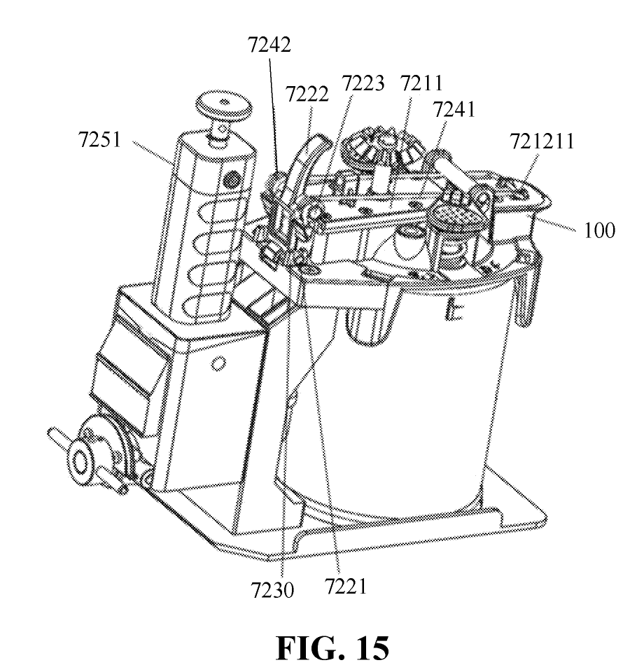

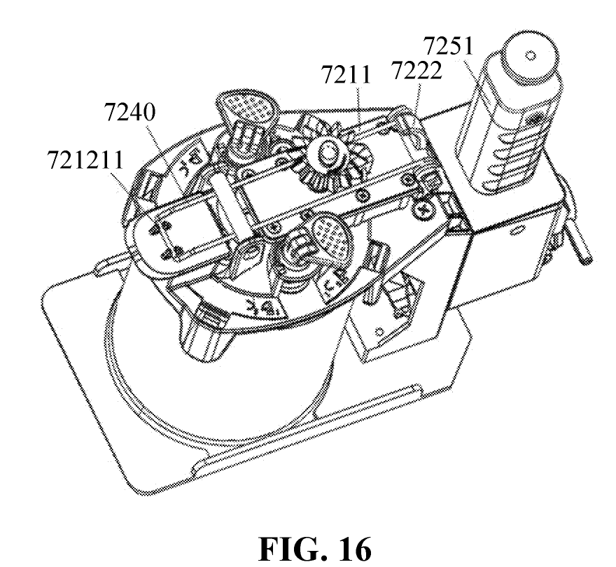

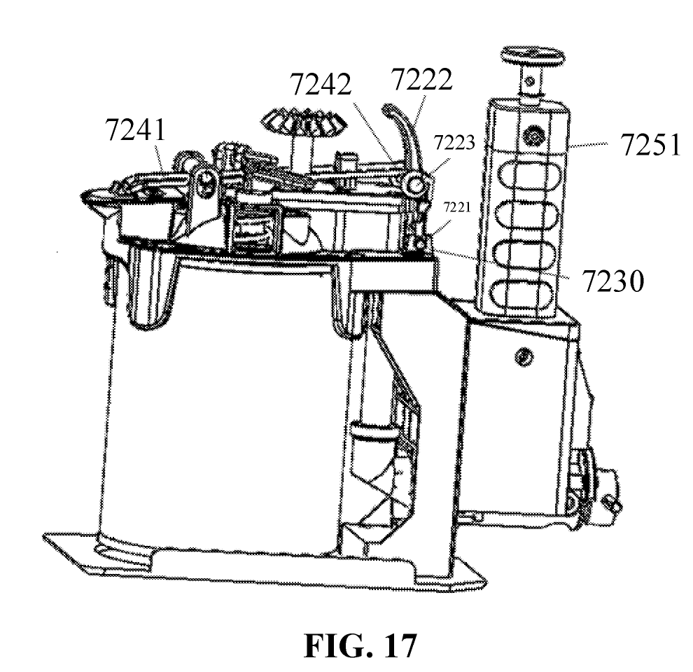

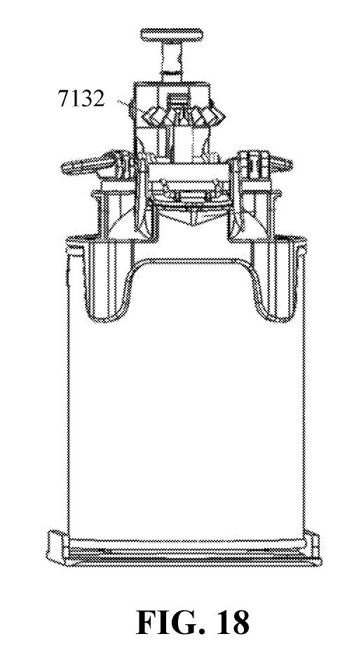

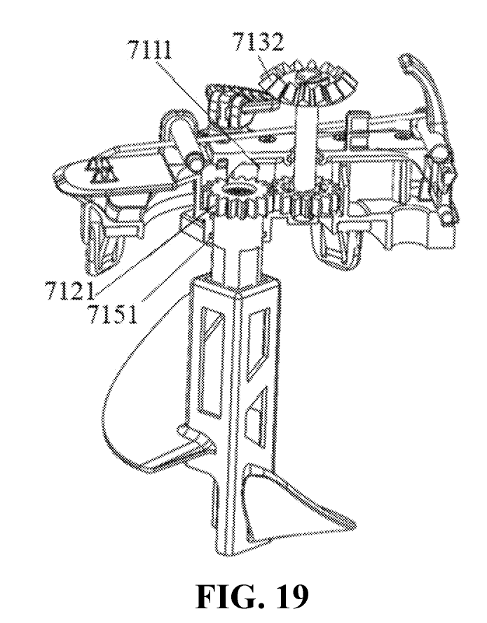

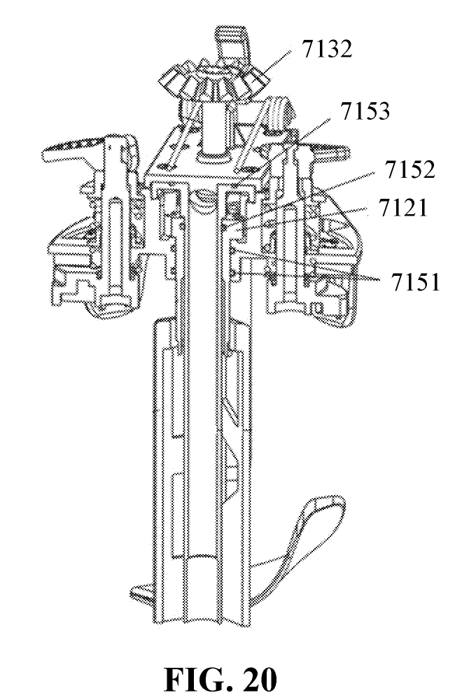

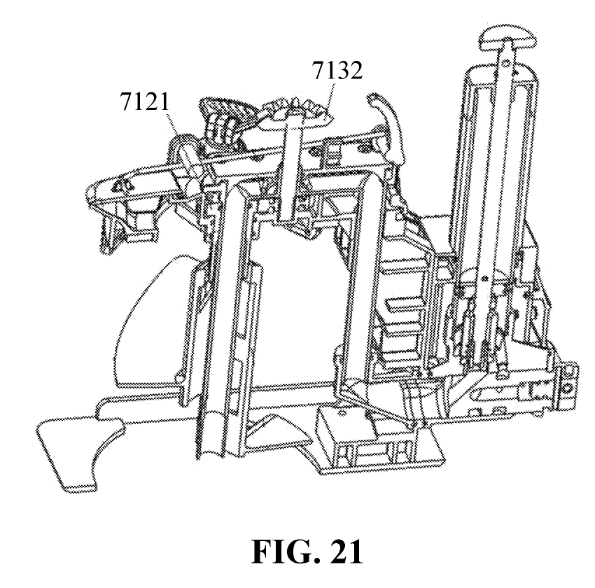

According to the embodiments of the present disclosure, a color mixing device is provided, and the color mixing device is configured for paint mixing, so as to be used in the field of architectural decoration and the field of automotive painting. The former can be used to mix paints as decorative paints (i.e., architectural paints), and the latter can be used to mix paints as automotive refinish paints. The following will specifically describe the structure and working principle of the color mixing device in conjunction with FIG. 1 to FIG. 21.

The color mixing device provided in the present disclosure includes a cover member, an injection path, and an injection mechanism. In an embodiment, the cover member includes a first side part and a second side part opposite to each other, and the first side part is configured to face a color paint raw material bucket to cover the color paint raw material bucket.

In an embodiment, the cover member can be, for example, a circular cover as a whole. The working state of the color mixing device is the state presented by the cover member after being covered on the color paint raw material bucket. Generally speaking, the color paint raw material bucket can be placed vertically, so the first side part and the second side part of the cover member can be opposite each other in the vertical direction. More specifically, the first side part can be the lower side part of the cover member, and the second side part can be the upper side part of the cover member.

In an embodiment, the injection path includes a first path extending from the first side part in a direction away from the cover member and a second path extending along the first side part; and the injection mechanism is connected to the cover member, and the injection mechanism is in communication with the second path.

In an embodiment, the injection path includes the first path and the second path as mentioned above. As mentioned in the above exemplary description, the first side part can be the lower side of the cover member. Therefore, the first path extends from the lower side part of the cover member in a direction away from the cover member. In fact, in the working state of the color mixing device, the first path extends into the interior of the color paint raw material bucket. In an embodiment, the second path can extend in a horizontal posture as presented by the cover member and be simultaneously connected to the cover member.

Thus, according to the color mixing device provided in the embodiments of the present disclosure, the color mixing device is communicated with the injection mechanism through the injection path. When the color mixing device is in the working state, the color mixing device can be directly mounted to the color paint raw material bucket, thereby ensuring that the color paste is transported from the injection path to the injection mechanism and then discharged, without the need to transfer the color paste in the color paint raw material bucket to another specially designed container. Therefore, the process steps of color mixing and the device used are simplified.

In an embodiment, the color mixing device further includes a stirring mechanism; the stirring mechanism includes a rotating assembly; the rotating assembly is sleeved on an outer side of the first path; and the rotating assembly can rotate around the first path to stir materials in the color paint raw material bucket.

The color mixing device provided by the embodiments of the present disclosure integrates a stirring mechanism, so that the color mixing device can be connected to the device such as a paint mixing stirrer or an automatic color mixer. Through the drive of the device such as the paint mixing mixer or the automatic color mixer, the stirring mechanism performs a stirring operation on the color paste in the color paint raw material bucket.

Further, according to the color mixing device provided by the embodiments of the present disclosure, the rotating assembly is sleeved on the outer side of the first path. When the rotating assembly stirs the color paste, it does not interfere with the first path. Meanwhile, the injection operation of the injection path does not impede the stirring process of the color paste by the rotating assembly. The sleeving position relationship between the rotating assembly and the first path is also conducive to further reducing the volume of the color mixing device.

In an embodiment, the injection path can further include a third path; the first path, the second path, and the third path are sequentially communicated; the third path is configured to be located on an outer side of the color paint raw material bucket when the cover member is covered on the color paint raw material bucket. The injection mechanism is connected to the cover member, and the injection mechanism is communicated with the second path via the third path. In an embodiment, the third path is equivalent to communicating the second path with the external environment of the color paint raw material bucket. In fact, it communicates the second path with the injection mechanism, so that the color paste in the color paint raw material bucket can be discharged sequentially along the first path, the second path, and the third path from the injection mechanism.

In an embodiment, the injection paths include three parts as mentioned above: the first path, the second path, and the third path. As mentioned in the above exemplary description, the first side part can be the lower side of the cover member. Therefore, the first path extends from the lower side part of the cover member in a direction away from the cover member. In fact, in the working state of the injection device, the first path extends into the interior of the color paint raw material bucket. In an embodiment, the second path can extend in a horizontal posture as presented by the cover member and be simultaneously connected to the cover member. In an embodiment, the third path is equivalent to communicating the second path with the external environment of the color paint raw material bucket. In fact, it communicates the second path with the injection mechanism, so that the color paste in the color paint raw material bucket can be discharged sequentially along the first path, the second path, and the third path from the injection mechanism.

Thus, according to the color mixing device provided in the embodiments of the present disclosure, the injection device is communicated with the injection mechanism through the injection path. When the injection device is in the working state, the injection path can be directly mounted to the color paint raw material bucket, thereby ensuring that the color paste is transported from the injection path to the injection mechanism and then discharged, without the need to transfer the color paste in the color paint raw material bucket to another specially designed container. Therefore, the process steps of color mixing and the device used are simplified.

In an embodiment, the injection paths can, for example, be formed by solid pipelines, that is, the first path is the first pipeline, the second path is the second pipeline, and the third path is the third pipeline. In an embodiment, both the first pipeline and third pipeline can be vertical pipelines, and the second pipeline can be, for example, a horizontal pipeline. Essentially, the first path, the second path, and the third path together form an inverted U-shaped or inverted V-shaped structure.

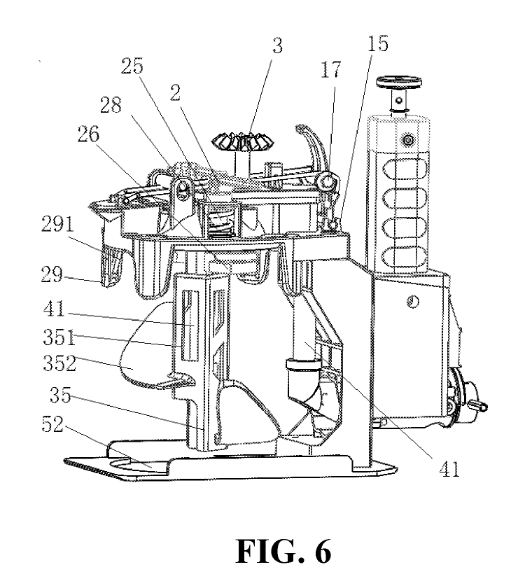

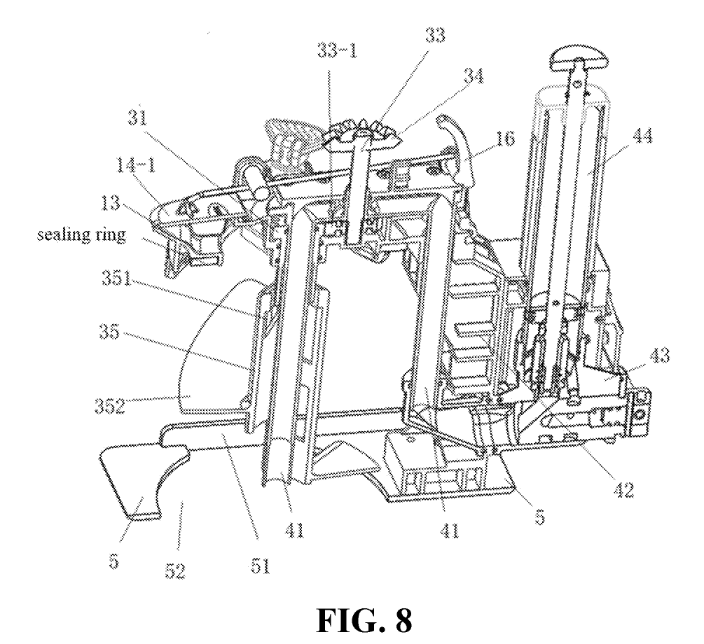

According to the color mixing device provided in the embodiments of the present disclosure, specifically, in conjunction with FIG. 6 and FIG. 8, in an embodiment, the cover member forms a substantive slurry cover. As mentioned in the above description, the injection path can be a solid pipeline, which can be, for example, a flow channel pipe 41. The first pipeline, that is, the vertical pipeline on the left side, can extend downward from the center position of the lower surface of the slurry cover; the second pipeline, that is, the horizontal pipeline at the top part, can pass through the interior of the slurry cover body; and the third pipeline, that is, the vertical pipeline on the right side, can extend downward from the outer side of the clamping jaw 29 on this side of the slurry cover (the description of the clamping jaw 29 will be mentioned in the subsequent description).

In an embodiment, when the slurry cover is correctly snapped to the bucket opening of the color paint raw material bucket (hereinafter referred to as the color paint bucket), the vertical pipeline on the right side of the flow channel pipe 41 is located on the outer side of the outer wall of the color paint bucket. In addition, the slurry cover can also be provided with a chamber, with the upper end of the first path, the second path, and the upper end of the third path all arranged within this chamber.

The slurry cover herein includes the slurry cover body, which forms a lid-like structure that can be mounted above the color paint bucket. Specifically, the slurry cover body has a fixing part 7211, an adjustment part, and a slurry outlet 100 communicated with the color paint bucket. The slurry outlet 100 can be a through hole formed on the fixing part 7211, or it can be a through hole formed by the slurry cover body and the bucket wall of the color paint bucket. It only needs to allow the exterior to communicate with the color paint bucket. The adjustment part can be formed as a plate-like structure and arranged above the slurry outlet 100. The adjustment part can slide relative to the fixing part 7211 to open or close the slurry outlet 100. Here, the adjustment part can be, for example, a cover plate 14-1, which will be further mentioned in the subsequent description.

In an embodiment, the wrench member can be, for example, a wrench 16. The wrench 16 is arranged upright, occupying little space. Specifically, one end of the wrench 16 is formed as a mounting part 7221 rotatably connected to the fixing part 7211, thereby achieving the connection between the wrench 16 and the slurry cover body. The mounting part 7221 can be formed as a rotary shaft structure.

In an embodiment, the other end of the wrench 16 is formed as a driving part 7222 located above the slurry cover body, which facilitates user control for opening the slurry outlet 100. The elastic member has a connecting part 7241 and an elastic part 7242. The elastic part 7242 is arranged between the wrench 16 and the fixing part 7211, so that when the wrench 16 is driven to rotate, the elastic part 7242 is compressed, and when the driving part 7222 is released, the wrench 16 can be pushed to reset under the rebound action of the elastic part 7242. The connecting part 7241 is respectively connected to the adjustment part and the wrench 16, so that when the wrench 16 is rotated, the wrench 16 can drive the adjustment part to slide via the connecting part 7241.

The following further explains the driving principle for opening and closing the slurry outlet 100.

Under normal conditions, the driving part 7222 protrudes from the top of the slurry cover body. Pressing the driving part 7222 causes the wrench 16 to rotate away from the fixing part 7211 and compress the elastic part 7242. At the same time, the connecting part 7241 drives the adjustment part to move closer to the fixing part 7211, thereby opening the slurry outlet 100. At this point, the color paint in the color paint bucket 1 can be poured out via the slurry outlet 100.

It should be noted that during the pouring process, continuous pressing force needs to be applied to the driving part 7222. After the pouring is completed, the driving part 7222 is released (that is, the user can loosen their fingers to remove the pressing force on the driving part 7222). At this time, the elastic part 7242 rebounds and returns to its original position, thereby driving the wrench 16 to rotate towards the direction closer to the fixing part 7211. During the rotation of the wrench 16 towards the fixing part 7211, the connecting part 7241 will be driven to move accordingly. The connecting part 7241 drives the adjustment part to close the slurry outlet 100. Thus, after the driving part 7222 is released, the slurry outlet 100 is automatically closed, which is convenient and labor-saving to operate.

In an embodiment, the wrench 16 is formed as a bar-shaped structure that is angled to the sliding direction of the adjustment part, which occupies a smaller space and is convenient for the user to press and apply force. In an optional embodiment, the extension direction of the bar-shaped structure wrench 16 is arranged perpendicular or approximately perpendicular to the sliding direction of the adjustment part, which makes the wrench 16 arranged vertically or approximately vertically. This not only reduces the occupied space but also avoids the interference between the wrench 16 and other components on the slurry cover of the color paint bucket when rotating, and can also meet the requirement of extracting the master color paint from the top.

Further, in an embodiment, a protruding positioning part 7223 can be formed on the side wall of the wrench 16, and the positioning part 7223 can be formed as a pin structure. The positioning part 7223 is arranged at the middle area in the length direction of the wrench 16, and the elastic part 7242 is wound around the circumferential side wall of the positioning part 7223. Moreover, one end of the elastic part 7242 away from the connecting part 7241 abuts against the fixing part 7211, so that the elastic part 7242 forms a coiling spring structure. Optionally, the protruding direction of the positioning part 7223 is arranged parallel to the axis of the mounting part 7221 of the above rotary shaft structure, so that the wrench 16 applies force to the elastic member more evenly and stably when rotating around the mounting part 7221.

Optionally, a positioning slot 72111 is arranged on the fixing part 7211, so that one end of the elastic part 7242 away from the connecting part 7241 is snapped in the positioning groove 72111, which achieves the fixation and positioning of the elastic part 7242 and the compression of the elastic part 7242 when the wrench 16 rotates.

Further, as mentioned above, the positioning parts 7223 are arranged on opposite side walls of the wrench 16, and the positioning parts 7223 protrude from their respective side walls. The two positioning parts 7223 are arranged coaxially, and two elastic parts 7242 are correspondingly provided. The connecting part 7241 is formed as a U-shaped structure with an opening facing the driving part 7222, so that the connecting part 7241 forms a bracket. Thus, the rotary shaft is configured to drive the stirring blades on the color paint bucket slurry cover to pass through the interior of the connecting part 7241, thereby providing a compact structural layout. The elastic part 7242 and the connecting part 7241 are integrally formed, which reduces the number of components, thereby providing a compact structure, and facilitating assembly.

In an embodiment, the elastic member is a filamentous structure, such as a steel wire, so that the connecting part 7241 is formed as a bracket structure with a certain flexibility and the elastic part 7242 can be wound to form a torsion spring structure.

In an embodiment, the adjustment part is provided with a convex part 72121 extending towards the connecting part 7241, wherein the convex part 72121 can be a block structure arranged at the top of the adjustment part; the convex part 72121 is provided with a snapping groove 721211 for the connecting part 7241 to extend into; the connecting part 7241 is snapped to the snapping groove 721211; the snapping groove 721211 clamps the side wall of the connecting part 7241, so as to achieve snapping fixation of the connecting part 7241 and the adjustment part, which is convenient for assembly and ensures reliable connection.

In an embodiment, multiple convex parts 72121 are provided, and these convex parts 72121 are arranged at intervals along the extension direction of the connecting part 7241 to ensure that the connecting part 7241 is firmly and reliably connected to the adjustment part.

Optionally, the convex parts 72121 are integrally formed with the adjustment part. In other examples, the convex part 72121 is assembled with the adjustment part through welding, bonding, or screw bolts.

Optionally, the driving part 7222 is formed as a curved rod-shaped structure. The driving part 7222 bends towards the direction close to the adjustment part, so that the driving part 7222 is formed as a hook-shaped structure. This makes it convenient for the user to continuously apply force with their fingers to control the driving part 7222 to open the slurry outlet 100, so as to avoid the situation where fingers slip off the driving part 7222 during the application of force to the wrench 16.

Furthermore, in an embodiment, the color paint bucket slurry cover further includes a seat structure 7230 mounted on the fixing part 7211, and the seat structure 7230 is hinged to the mounting part 7221. Specifically, the top of the seat structure 7230 is provided with a groove, and the mounting part 7221 is embedded in the groove, so as to achieve radial limit for the mounting part 7221 and ensure that the mounting part 7221 can only rotate around its own axis, so that the position of the wrench 16 relative to the slurry cover body is fixed and it is rotatably connected to the fixing part 7211.

In an embodiment, the color paint bucket slurry cover further includes a pressing assembly. Specifically, the pressing assembly includes a supporting member and a pressing member; the supporting member is formed as a plate-shaped structure and is mounted on the side of the fixing part 7211; and a mounting hole is arranged in the supporting member. The pressing member is formed as a cylindrical structure and passes through the mounting hole; the pressing member abuts against one side of the connecting part 7241 facing away from the slurry cover body, so that the pressing member can apply an abutment force to the connecting part 7241, and the connecting part 7241 can move along the preset trajectory when it moves with the wrench 16.

Optionally, two supporting members are provided and symmetrically arranged relative to the fixing part 7211, which are respectively connected to the two ends of the pressing member in the length direction to avoid uneven force application to the connecting part 7241 caused by the lifting of one end of the pressing member warping up. Furthermore, the mounting hole on the supporting member is formed as a rod-shaped hole extending in the vertical direction, so that the pressing member cannot move in the sliding direction of the adjusting part, but can only move up and down within the mounting hole. Thus, it ensures that during the translation of the connecting part 7241, the pressing member can only provide a relatively high adaptive abutment force, thereby guaranteeing that the connecting part 7241 remains on the preset movement trajectory.

Optionally, the color paint bucket slurry cover further includes a pump body communicated with the interior of the color paint bucket. The pump body can be a volumetric metering pump 44, specifically a volumetric pump driven by a stepping motor, a servo motor, or a direct current motor, such as a piston pump or a plunger pump. When the pump body is driven, the color paint in the color paint bucket can be drawn into the pump body and discharged through the liquid outlet of the valve body.

In an embodiment, the pump body is arranged outside the color paint bucket. Specifically, the pump body is arranged on one side of the fixing part 7211 away from the adjustment part, so that when the wrench 16 rotates, the driving part 7222 can move in the direction close to or away from the pump body. Since the wrench 16 is arranged vertically, the driving part 7222 is arranged above the slurry cover body, so as to provide a larger space at the back of the color paint bucket for mounting the pump body.

In an embodiment, the pump body and the slurry outlet 100 are arranged on opposite sides of the wrench 16. Optionally, at least part of the pump body is located above the slurry cover body to form the handle 7251, which can be understood as part of the housing of the pump body forming the handle 7251 for the user to hold, wherein the handle 7251 and the driving part 7222 are arranged at intervals in the sliding direction of the adjustment part. Thus, when operated by a user, the handle 7251 (i.e., the outer wall of the pump body) can be held with one hand, and the driving part 7222 can be pulled by the index finger or middle finger, thereby facilitating the opening of the slurry outlet 100 and enabling one-handed operation for precisely pouring out the paint.

In an embodiment, the slurry cover body is mounted on the color paint bucket, and the slurry cover body has a fixing part 7211, an adjustment part, and a slurry outlet 100 communicated with the color paint bucket. One end of the wrench 16 is rotatably connected to the fixing part 7211 and the other end is formed as a driving part 7222. The elastic part 7242 of the elastic member is arranged between the wrench 16 and the fixing part 7211, and the connecting part 7241 is respectively connected to the adjustment part and the wrench 16. Pressing the driving part 7222 causes the wrench 16 to rotate in a direction away from the fixing part 7211 and compress the elastic part 7242, and the connecting part 7241 drives the adjustment part to move in a direction close to the fixing part 7211, so as to open the slurry outlet 100. Releasing the driving part 7222 allows the elastic part 7242 to reset, thereby driving the wrench 16 to rotate toward a direction close to the fixing part 7211, so that the connecting part 7241 drives the adjustment part to close the slurry outlet 100. Since the wrench 16 is arranged upright, the driving part 7222 is located above the slurry cover body. This saves the space occupied by the wrench 16 in the structure of the color paint bucket slurry cover, which facilitates user operation, and reduces the risk of interference between the wrench 16 and other components when the wrench 16 rotates, thereby improving the adaptability of the color paint bucket slurry cover.

According to the color mixing device provided in the embodiments of the present disclosure, the stirring mechanism can further include a driving assembly, wherein the driving assembly can pass through the second path, and the driving assembly can be in transmission connection with the rotating assembly. Thus, according to the color mixing device provided in the embodiments of the present disclosure, the driving assemblies are arranged in a way passing through the second path, which further facilitates the reduction of the volume of the color mixing device.

According to the color mixing device provided in the embodiments of the present disclosure, specifically, the driving assembly can include a driving shaft and a driving gear passing through the second path; the rotating assembly can include a rotating body that can rotate around the first path; the driving gear is located between the first path and the third path; and the driving gear can be in transmission connection with the rotating body.

According to the color mixing device provided in the embodiments of the present disclosure, specifically, in conjunction with FIG. 6 and FIG. 8, in an embodiment, as mentioned in the above description, the cover member is formed as a substantive slurry cover, and the injection path can be a solid pipeline, which can be, for example, a flow channel pipe 41. The first pipeline, that is, the vertical pipeline on the left side, can extend downward from the center position of the lower surface of the slurry cover; the second pipeline, that is, the horizontal pipeline at the top part, can pass through the interior of the slurry cover body; and the third pipeline, that is, the vertical pipeline on the right side, can extend downward from the outer side of the clamping jaw 29 on this side of the slurry cover (the description of the clamping jaw 29 will be mentioned in the subsequent description).

In an embodiment, when the slurry cover is correctly snapped to the bucket opening of the color paint raw material bucket (hereinafter referred to as the paint bucket or color paint bucket), the vertical pipeline on the right side of the flow channel pipe 41 is located on the outer side of the outer wall of the color paint bucket. The rotating body of the stirring mechanism 3 includes a shaft sleeve 31 sleeved on the vertical pipeline on the left, and a sealing ring can be arranged between the inner wall of the shaft sleeve 31 and the outer wall of the vertical pipeline on the left side. The shaft sleeve 31 can be in a stepped shape, and the upper part of the shaft sleeve 31 can be arranged within a chamber formed inside the slurry cover through a shaft shoulder formed by its own stepped structure. As mentioned in the above description, the shaft sleeve 31 can rotate relatively with respect to the slurry cover (in fact, it can rotate about an axis extending in the vertical direction), and a sealing ring can also be arranged between the slurry cover and the outer wall of the shaft sleeve 31.

In an embodiment, the interior chamber of the slurry cover can be provided with the above-mentioned driving shaft, and the driving shaft herein can be a rotatable stirring blade main shaft 33. Specifically, the lower end of the stirring blade main shaft 33 can be located in the chamber inside the slurry cover, and a gear 33-1 is arranged on the lower end of the stirring blade main shaft 33. The upper end of the stirring blade main shaft 33 extends from the chamber inside the slurry cover and is located above the slurry cover.

In an embodiment, the upper end of the stirring blade main shaft 33 can extend above the slurry cover, and a gear, such as a bevel gear 34 (or a spur gear), is arranged at the upper end of the stirring blade main shaft 33. The engagement structure of the bevel gear 34 can drive a greater number of color paint buckets. (without increasing power, the bevel gear has a larger force transmission area, and from the perspective of gear strength, power is not increased). In an embodiment, a gear surface is also provided on an external cylindrical surface of the upper part of the shaft sleeve 31. This gear surface is engaged with the gear 33-1 and ultimately drives the shaft sleeve 31 to rotate through the stirring blade main shaft 33.

From another perspective, the shaft sleeve 31 can serve as the first transmission member, and the stirring blade main shaft 33 can serve as the second transmission member. One end of the first transmission member can extend into the color paint bucket and be connected to the stirring blade, and the other end of the first transmission member is provided with a first gear 7121. The rotation axis of the first gear 7121 is coaxially arranged with the axis of the first transmission member, wherein the first gear 7121 can be integrally formed with the first transmission member, or the first gear 7121 can be connected to the first transmission member by a key connection.

In an embodiment, one end of the second transmission member is provided with a second gear engaged with the first gear 7121, which is essentially the gear 33-1 as mentioned above, wherein the second gear can be integrally formed with the second transmission member, or the second gear is connected to the second transmission member by a key connection. The first gear 7121 and the second gear are arranged in the mounting chamber 7111, which can protect the engagement connection between the first gear 7121 and the second gear, thereby ensuring the effective transmission between the first transmission member and the second transmission member, and improving the service life.

More specifically, in the embodiment, the other end of the second transmission member is formed as an external driving end 7132 extending out of the slurry cover body, and the driving end 7132 is connected to a power device that drives the stirring blades to rotate, wherein the power device is a rotating motor or a rotating cylinder or other mechanisms capable of driving the second transmission member to rotate.

In the embodiment, the stirring blades and the first gear 7121 are arranged on two ends of the first transmission member in the axial direction, and the driving end 7132 and the second gear are arranged on two ends of the second transmission member in the axial direction.

In the embodiment, the second transmission member is arranged non-coaxially with the first transmission member, so that the first transmission member that drives the stirring blade to rotate and the driving end 7132 connected to the power device are arranged at intervals from each other in the radial direction of the first transmission member or the second transmission member. In this way, automatic paint mixing can be achieved inside the original color paint bucket with the slurry cover by driving the power device. Moreover, when meeting the requirements for the stirring of the color paste by the stirring blades, the second transmission member can be arranged at a position that meets the layout requirements of other components on the slurry cover body. In this way, the interference of the second transmission member can be avoided when reducing the volume of the color paint bucket stirring blade cover, thereby meeting the application requirements of the color mixing and stirring apparatus.

Optionally, the axes of the first transmission member and the second transmission member are parallel to each other, wherein the axis of the first transmission member extends in a direction toward the interior of the color paint bucket, and the axis of the second transmission member extends in a direction toward the exterior of the color paint bucket.

In an optional embodiment, the power device is connected to the output shaft via a coupling, and the output shaft is connected to the driving end 7132, thereby achieving power transmission from the driving end 7132 to the second gear via the second transmission member. Through the engagement between the second gear and the first gear 7121, the power is transmitted to the stirring blades via the first transmission member, thereby achieving the rotation of the stirring blades within the color paint bucket, and realizing the stirring operation.

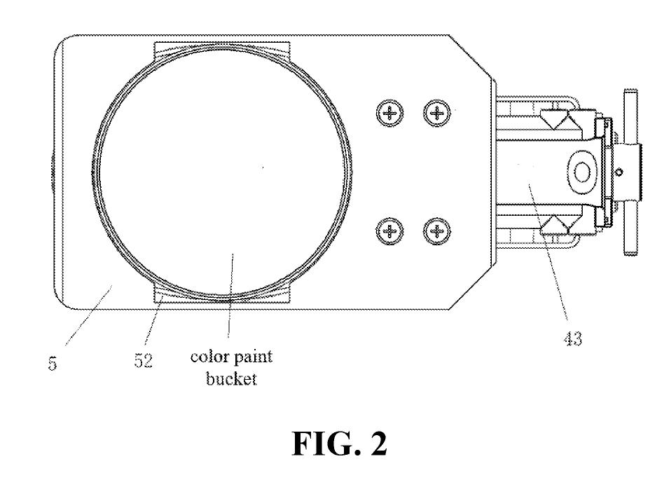

In an optional embodiment, as shown in FIG. 1 and FIG. 2, the driving end 7132 is a bevel gear. Thus, one power device can be used to drive the driving end 7132 of multiple stirring slurry covers in the color paint bucket to rotate. Specifically, multiple color paint buckets provided with color paint bucket stirring slurry covers are arranged in a straight line, wherein the extension direction of the output shaft connected to the power device is the same as the arrangement direction of the multiple color paint buckets; multiple bevel gears are mounted on the output shaft and are arranged at intervals with each other; and the bevel gears on the output shaft are engaged with the driving end 7132. This meets the requirement of timed stirring after the color paint bucket containing the color paste is placed on a rack, and it only needs one power device to achieve stirring of the color paste in the multiple color paint buckets, thereby saving costs.

In the embodiment, the first gear 7121 and the second gear are two cylindrical gears engaged with each other. Specifically, both the first gear 7121 and the second gear can be spur cylindrical gears, or both can be helical cylindrical gears.

In the optional embodiment, the axis of the first transmission member is collinear with the center axis of the color paint bucket, thus ensuring that the stirring blades are arranged at the middle position of the color paint bucket, thereby enhancing the uniformity of the stirring of the color paste.

Furthermore, in the embodiment, the first transmission member and the second transmission member are arranged parallel to each other; a slurry outlet 100 is arranged on the main slurry cover body; the slurry outlet 100 can communicate the color paint bucket with the outside when the slurry cover body is opened.

Optionally, the second transmission member is arranged on one side of the first transmission member away from the slurry outlet 100, that is, the second transmission member and the slurry outlet 100 are arranged at the two ends of the first transmission member in the radial direction. In other optional embodiments, the second transmission member is arranged between the first transmission member and the slurry outlet 100, or in other arrangement method that can satisfy the opening of the slurry outlet 100 and the transmission requirements between the second transmission member and the first transmission member.

In addition, in the embodiment, the color paint bucket stirring slurry cover further includes a fluid pipeline mounted on the main slurry cover body, and the fluid pipeline is formed as a curved tubular structure. Specifically, one end of the fluid pipeline extends into the color paint bucket, and the other end is communicated with the outside of the color paint bucket. Thus, under the action of the pump, the color paste in the color paint bucket can be pumped out to the outside of the color paint bucket.

Furthermore, in the embodiment, the interior of the first transmission member is hollow; the fluid pipeline passes through the interior of the first transmission member; and the engagement connection between the first gear 7121 and the second gear is arranged below the fluid pipeline. This meets the arrangement requirements of the fluid pipeline in the stirring slurry cover of the color paint bucket, and ensures the smooth transportation of the color paste in the fluid pipeline. At the same time, it does not affect the rotation of the stirring blades driven by the first transmission member, so as to meet the stirring requirements.

Furthermore, in the embodiment, the color paint bucket stirring slurry cover further includes a first sealing member 7151, wherein the first sealing member 7151 can adopt an annular sealing ring; the first sealing member 7151 is arranged between the outer wall of the first transmission member and the chamber wall of the mounting chamber 7111, thereby preventing the color paste in the color paint bucket from splashing into the mounting chamber 7111 during stirring. Optionally, an annular groove is arranged on the chamber wall of the mounting chamber 7111, so that part of the first sealing member 7151 is embedded in the groove, and part of the first sealing member 7151 extends out of the groove to abut against the outer wall of the first transmission member, thereby achieving a sealed connection between one end of the first transmission member facing the interior of the color paint bucket and the mounting chamber 7111.

Optionally, the first sealing member 7151 is arranged below the engagement point of the first gear 7121 and the second gear, thereby effectively preventing the color paste from entering the mounting chamber 7111 and causing corrosion or contamination to the first transmission member and the second transmission member.

Optionally, multiple first sealing members 7151 are provided, and these multiple first sealing members 7151 are arranged at intervals along the axial direction of the first transmission member, thereby enhancing the sealing effect.

In an optional embodiment, the color paint bucket stirring slurry cover further includes a second sealing member 7152 and a third sealing member 7153. Both the second sealing member 7152 and the third sealing member 7153 can adopt annular sealing rings. Specifically, the second sealing member 7152 is arranged between the inner wall of the first transmission member and the outer wall of the fluid pipeline, thereby preventing the color paste from entering the mounting chamber 7111 from the interior of the first transmission member of the shaft sleeve structure; and the third sealing member 7153 is arranged between the fluid pipeline and the chamber wall of the mounting chamber 7111, which prevents the color paste from entering the mounting chamber 7111 via the fluid pipeline, thereby protecting the parts of the first transmission member and the second transmission member arranged in the mounting chamber 7111, and ensuring the reliable transmission of power between the first transmission member and the second transmission member.

Optionally, the inner wall of the first transmission member is provided with a groove configured for the assembly of the second sealing member 7152, and the top of the fluid pipeline is provided with a groove configured for the assembly of the third sealing member 7153.

According to the color mixing device provided in the present disclosure, the first transmission member and the second transmission member are arranged non-coaxially; the first transmission member and the second transmission member are driven by the first gear and the second gear, so that the first transmission member that drives the stirring blade to rotate and the driving end connected to the power device are arranged at intervals in the radial direction; the other end of the second transmission member is formed as a driving end extending out of the slurry cover body; and the driving end is connected to the power device that drives the stirring blades to rotate. In this way, automatic paint mixing can be achieved inside the original color paint bucket with the slurry cover by driving the power device. Moreover, when meeting the requirements for the stirring of the color paste by the stirring blades, the second transmission member can be arranged at a position that meets the layout requirements of other components on the slurry cover body. In this way, the interference of the second transmission member can be avoided when reducing the volume of the color paint bucket stirring blade cover, which facilitates the mounting of the power unit and enables one power device to simultaneously drive the driving ends on the multiple stirring slurry covers of the color paint bucket to rotate, thereby saving costs.

In addition, the first gear and the second gear are arranged in the mounting chamber of the slurry cover body, which can protect the engagement connection between the first gear and the second gear, thereby ensuring the effective transmission between the first transmission member and the second transmission member, and improving the service life. In the following description, the descriptions mentioned in the above sections will be restated from another perspective in conjunction with the drawings.

According to the color mixing device provided in the embodiments of the present disclosure, the rotating assembly can further include multiple blades located on the outer side of the rotating body. In the embodiments, these blades are configured to stir the color paste. In an embodiment, the rotating body can have multiple sides distributed sequentially in the circumferential direction, with each blade connected to at least two side surfaces. In an embodiment, the rotating body presents a prismatic shape due to the foregoing multiple side surfaces. Each blade is connected to at least two side surfaces, so that the blade spans at least one edge, thereby greatly increasing the flexural strength of the blade. In an embodiment, the specific forms of the blades and the rotating body will be further described in the subsequent description.

According to the color mixing device provided in the embodiments of the present disclosure, the rotating body has a cavity, and the inner side part of the cavity is arranged at intervals from the outer side part of the first path. This cavity arrangement is conducive to sleeving of the rotating body on the first path. In an embodiment, the rotating body has multiple through holes, each of which is connected to the cavity and the environment where the rotating body is located (such as the environment inside the color paint bucket). In an embodiment, the shape of these through holes reduces the frictional resistance between the rotating body and the liquid, thus ensuring the stirring effect when making it less likely for the air to be stirred into the color paste.

According to the color mixing device provided in the embodiments of the present disclosure, each side surface of the rotating body can be provided with at least one through hole; and the through holes on the adjacent side surfaces are alternately arranged in an opposite direction of the first side part and the second side part.

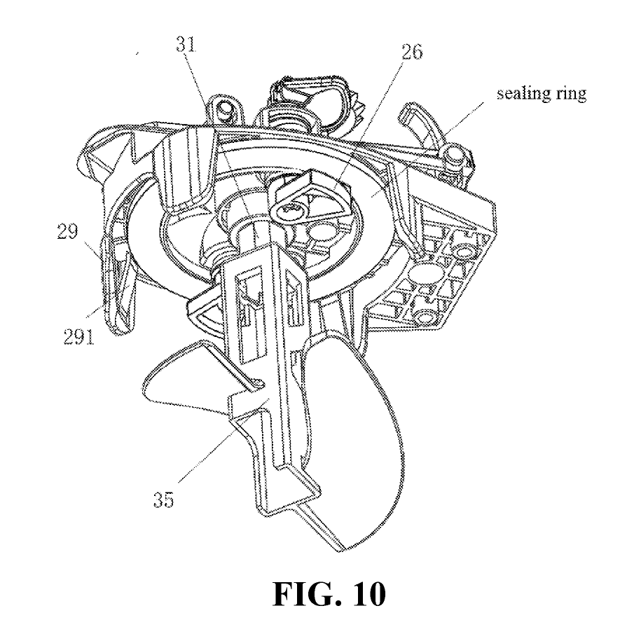

In an embodiment, in conjunction with FIG. 10 to FIG. 13, the rotating body can further include a stirring square column 35. Specifically, the stirring square column 35 is arranged at the lower part of the shaft sleeve 31. The upper end of the stirring square column 35 can be snapped to the elastic jaw arranged at the lower part of the shaft sleeve 31 through a step platform. However, the two can either be detachably connected through other connection methods, or directly manufactured into the same component, that is, integrally formed.

In an embodiment, the shape of the stirring square column 35 can be a rectangular vertical hollow configuration, and the inner surface of the stirring square column 35 does not directly contact the outer wall of the vertical pipeline on the left side of the flow channel pipe 41. Holes 351 can be arranged on the wall surface of the stirring square column 35. The configurations of the holes 351 on different surfaces can be the same, such as different lengths. By using the holes 351 on various surfaces of different lengths, the holes 351 on adjacent surfaces can be arranged in a staggered manner. In this way, the overall structural strength of the stirring square column 35 is guaranteed.

In an embodiment, as mentioned above, the outer surface of the stirring square column 35 can also be provided with blades 352, and the root of the blades 352 can be simultaneously connected to two adjacent side surfaces in the stirring square column 35, that is, straddling one edge, which can greatly enhance the flexural strength of the blades. The edge of the stirring square column 35, compared with the cylindrical structure, inherently has a certain stirring effect. The holes 351 on the stirring square column 35 reduce the frictional resistance between the stirring square column 35 and the liquid, thus enabling the stirring square column 35 to have a larger volume. On the basis of ensuring the stirring effect, it is also less likely to stir the air into the color paste, which would affect the mixing accuracy of color paste (because the more bubbles there are, the more inaccurate the volume measurement and other measurement methods will be).

According to the color mixing device provided in the embodiments of the present disclosure, the injection mechanism can include a pump, such as a volumetric metering pump (or other types of pumps such as peristaltic pumps) and a liquid outlet. The volumetric metering pump can draw the material in the color paint raw material bucket through the injection path and discharge it through the liquid outlet. In an embodiment, the cover member has a slurry outlet 100; the color mixing device further includes a cover plate and a wrench in transmission connection with the cover plate; and the wrench swings to drive the cover plate to cover and expose the slurry outlet 100.

In an embodiment, the wrench and the volumetric metering pump are located on the same side of the cover member, which facilitates the operator to use the volumetric metering pump as the handle when using the wrench. Optionally, when observed along the movement direction of the cover plate, the wrench and the volumetric metering pump overlap, thereby further facilitating the operation of the wrench.

Specifically, the injection mechanism 4 can include a pump bracket 42. The pump bracket 42 can mainly extend in the vertical direction, that is, mainly in an up-and-down direction. The upper part of the pump bracket 42 can be fixedly connected to the slurry cover, and a horizontal valve body 43 can be fixedly mounted on the middle-lower part of the pump bracket 42, wherein the valve body 43 can preferably be a return valve. In an embodiment, the volumetric metering pump can preferably be a combined large and small pump, and the feed end of the valve body 43 can be connected to the vertical pipeline on the right side of the flow channel pipe 41, such as the valve body structure and pump structure in patents CN201410792479.7, CN201711400600.7, or CN201310045508.9. In an embodiment, the return valve can have a return channel. When the valve body 43 is in the closed state, that is, no color paste is injected, the return channel is communicated, that is, the valve body 43 is communicated with the vertical pipeline on the right side of the flow channel pipe 41, and the color paste can flow back into the color paint bucket.

In an embodiment, the vertical pipeline on the right side of the flow channel pipe 41 can be connected to the above volumetric metering pump 44 through the valve body 43, and the valve body 43 has on-off and flow switching functions. It is repeated herein that the volumetric metering pump 44 can be a volume pump driven by a stepping motor, a servo motor, or a direct current motor, such as a piston pump or a plunger pump. By being driven, the color paste in the color paint bucket can be drawn into the volumetric metering pump 44 and discharged through the liquid outlet of the valve body 43 (i.e., the above liquid outlet).

In an embodiment, the volumetric metering pump 44 can be used as a fixed volumetric metering pump or as a general volume pump when in use, and the metering function is accomplished by other weighing modules. The lower end of the volumetric metering pump 44 can be vertically mounted on the upper part of the valve body 43, and the liquid paths inside the two can be communicated with each other. In an embodiment, as described above, the middle-upper end of the volumetric metering pump 44 is located on one side of the wrench 16, and the distance between the two is optimally designed according to their respective dimensions, so that the outer wall of the volumetric metering pump 44 here can serve as the handle 7251 of the color mixing device mentioned in the above description. That is, when a user holds the handle 7251 here (the outer wall of the middle-upper part of the volumetric metering pump 44) with one hand, the user index finger or middle finger can pull the wrench 16, thereby conveniently controlling the cover plate 14-1 on the slurry outlet 100 to slide back and forth, and enabling one-handed operation and precisely pouring out of the material.

According to the color mixing device provided in the embodiments of the present disclosure, the color mixing device can further include at least three clamping jaws in a same extension direction as the first path; and the at least three clamping jaws can be connected to the cover member. In an embodiment, each of the clamping jaws has an inclined surface facing the color paint raw material bucket, and one side of the inclined surface close to the cover member is closer to the color paint raw material bucket than one side of the inclined surface farther from the cover member.

In an embodiment, when sleeving the slurry cover on the color paint bucket, the slurry cover can be manually and visually adjusted to be concentric with the color paint bucket first, so as to ensure that the slurry cover is mounted in place without deviation. As mentioned above, at least three clamping jaws 29 facing downward can be arranged around the periphery of the slurry cover; each clamping jaw 29 can be provided with a pressing jaw sheet 291; the lower end of the pressing jaw piece 291 can be connected to the lower end of the inner surface of the clamping jaw 29; the pressing jaw sheet 291 has the inclined surface described above; and the upper end of the pressing jaw sheet 291 can be inclined obliquely upward toward the central axis of the slurry cover.

For example, four clamping jaws can be provided. The four clamping jaws can be arranged on the outer side of the color paint bucket. Pressing the pressing jaw sheet 291 against the outer wall of the color paint bucket can adjust the concentricity between the slurry cover and the color paint bucket. When the slurry cover is sleeved on the color paint bucket, it can be automatically self-centering according to the outer diameter of the color paint barrel, so as to ensure that the slurry cover is centered without the need for manual adjustment of its position. The four clamping jaws evenly distributed around the slurry cover can be identical in shape and size.

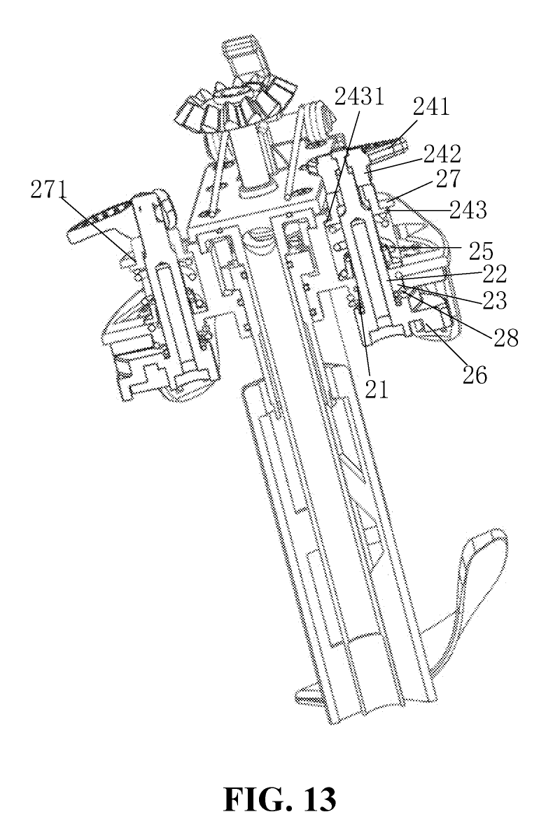

The color mixing device provided according to the embodiments of the present disclosure can further include a pressing mechanism. As shown in FIG. 13, a through hole 21 can be arranged on the slurry cover; a pressing rod 22 can pass through the through hole 21; a sealing sleeve 23 can be sleeved on the pressing rod 22; the sealing sleeve 23 can have a flanged edge; and the rim can press against the slurry cover 3.

In an embodiment, the pressing mechanism can further include a pressing spring 25; the lower end of the pressing rod 22 can be formed as a pressing foot 26; and the upper end of the pressing rod can be hinged to a cam lifting handle 241; and the cam surface 242 of the cam lifting handle 241 can be in contact with the upper surface of the cam seat. In an embodiment, the cam seat can be a movable pipe sleeve 243 sleeved outside the pressing rod 22; the upper surface 244 of the movable pipe sleeve 243 can be in contact with the cam surface 242 of the cam lifting handle; the movable pipe sleeve 243 can also be provided with a flange-shaped rim 2431; the upper end of the pressing spring 25 can abut against the flanged edge 2431 of the movable pipe sleeve 243; and the pressing spring 25 is located between the flange of the sealing sleeve 23 and the cam lifting handle 241.

Before the present disclosure, when pressing the slurry cover, it was necessary to simultaneously press and rotate a knob to ensure that the pressing foot was snapped on the color paint bucket. To ensure the sealing of the slurry cover, the pressing spring of the knob was often designed to be highly elastic. Rotating the knob required maintaining continuous pressing on the compression spring, which generated a large reaction force on the fingers, which causes significant discomfort and effort for the operator. Repeated installations would greatly increase the operator labor intensity and reduce operational comfort.

However, according to the embodiments of the present disclosure, when the cam lifting handle 241 is used, the long axis of the cam lifting handle 241 contacts the upper surface of the cam seat when pressing the compression spring 25. At this time, by rotating the cam lifting handle 241 horizontally, the pressing foot 26 is pressed against the opening of the color paint bucket. During the entire horizontal rotation process, the operator only needs to hold the handle part to prevent the cam from returning, thereby maintaining continuous compression on the compression spring. The working pressure on the fingers is reduced, physical effort is saved, and operation becomes more convenient.

In an embodiment, the bracket 27 is correspondingly arranged above the through hole 21 on the slurry cover; a flat plate on the bracket 27 is provided with a bracket through hole 271; the movable pipe sleeve 243 can be arranged inside the bracket through hole 271; and the movable pipe sleeve 243 and the bracket through hole 271 can slide and fit together. In this way, the entire pressing mechanism 2 is supported by two through holes at the top and bottom, which is more stable. The outer periphery of the pressing foot between the lower part of the slurry cover and the pressing rod can be provided with a balance spring 28, so as to ensure that the pressing mechanism 2 does not shift when the pressing foot is in a relaxed state. For example, the pressing mechanism can be two, four, or more, and can be evenly distributed on the slurry cover in the circumferential direction.

In an embodiment, the pressing foot can have a sector ring shape. A vertical surface is arranged along a connecting line between the two arc lines of the sector ring shape. The vertical surface divides the sector ring surface into two pressing foot surfaces of different heights, namely a first pressing foot surface and a second pressing foot surface. With such a design, a same pressing foot can press color paint buckets having different bucket opening thicknesses by using multiple pressing surfaces, unlike in the prior art where one pressing foot can only press the color paint buckets with the same bucket opening thickness. The two-stage pressing foot according to an embodiment of the present disclosure can be configured to fit color paint buckets of different rim heights, thereby increasing versatility. The new pressing foot is specifically designed and manufactured with two working surfaces of different heights, and the distances from the upper and lower working surfaces to the sealing ring contact surface are different. In this way, it can be configured to fit color paint buckets of different rim heights. When the rim height of the paint barrel is less than 7 mm, the upper plane can be used to contact and seal the color paint bucket. When the rim height is greater than 7 mm but less than 12 mm, the lower plane can be used to contact and seal the color paint bucket. Designing the pressing foot of the slurry cover into different specifications with different height dimensions achieves compatibility.

As shown in FIG. 1 to FIG. 9, in conjunction with the above description, the elastic member, the supporting member, and the pressing member mentioned in the above description can be collectively regarded as belonging to the paint outlet mechanism 1 included in the color mixing device. The elastic member can be, for example, a rectangular elastic frame 11. The pressing member can be, for example, a pressing rod 12 pressed on the two rods of the rectangular elastic frame 11. The supporting member can be, for example, fixing seats 13 configured to fix the pressing rod 12 and located on two sides of the elastic frame 11. In an embodiment, the pressing rod 12 of the cylindrical structure can actually be a circular shaft structure, and two fixing seats 13 can be vertical plate structures. The bar-shaped mounting holes arranged on the fixed seats 13 can be represented by a pressing rod shaft through hole 14, whose hole diameter is greater than the maximum diameter of the pressing rod 12. The through hole is preferably a long strip in the vertical direction (at this time, the width is greater than the maximum diameter of the pressing rod 12). The pressing rod 12 is snapped into the through hole by the cylindrical convex parts at its two ends.

In an embodiment, with the fixing seat of the above structure, when the pressing rod shaft moves only in a plane perpendicular to the axis of the pressing rod, it cannot be removed from the hole of the fixing seat. Since the rectangular elastic frame 11 is pressed downward by the pressing rod 12, the pressing rod 12 cannot move back and forth but can move up and down within the through hole, thereby ensuring that when the rectangular elastic frame 11 moves back and forth, the pressing rod 12 provides a relatively high adaptive abutment force, thereby keeping the rectangular elastic frame 11 on the preset movement trajectory.

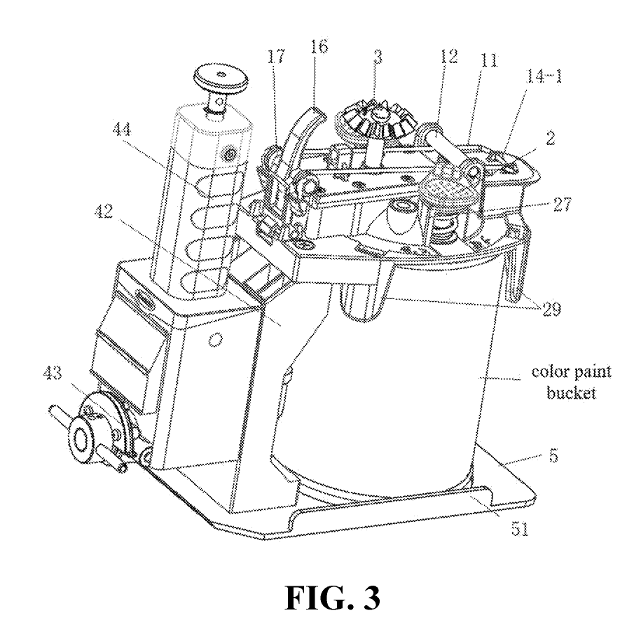

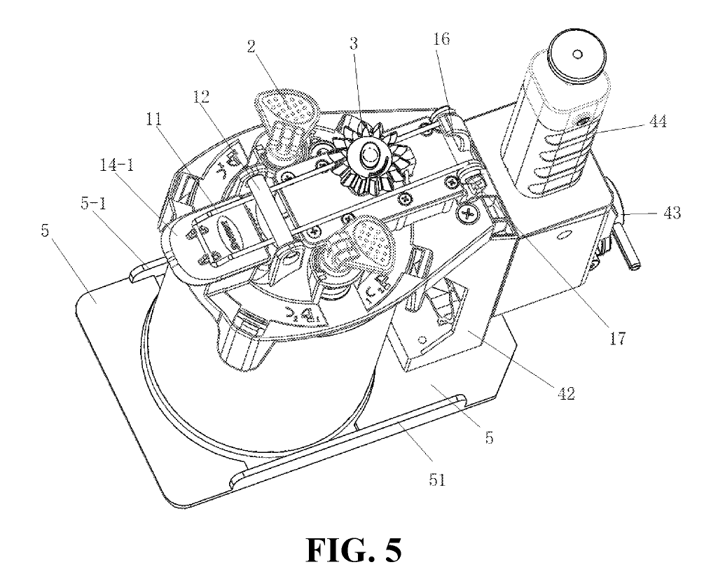

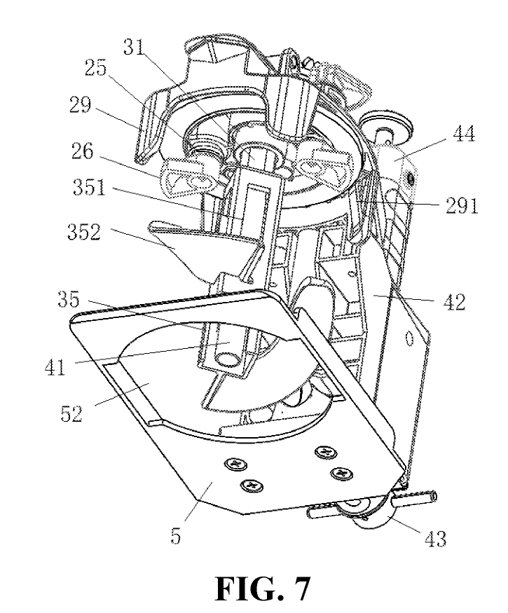

As shown in FIG. 1, FIG. 3, FIG. 5, FIG. 7, and FIG. 8, the paint outlet mechanism 1 can further include the above slurry outlet 100 arranged on the slurry cover body, and the cover plate 14-1 capable of sliding horizontally can be arranged on the slurry outlet 100. The cover plate 14-1 is connected to one end of the elastic frame 11, and driven by the horizontal movement of that end of the elastic frame 11, the cover plate 14-1 slides horizontally on the upper surface of the slurry outlet 100.

In an embodiment, the paint outlet mechanism 1 can further include a wrench supporting base 15 arranged on the slurry cover body. The wrench supporting base 15 is connected to the top of the pump bracket 42. The fixing seat can be, for example, the wrench supporting base 15. As described above, a wrench 16 can be mounted thereon, and the lower end of the wrench 16 can swing back and forth about the wrench supporting base 15. A shaft pin 17 is arranged at the middle part of the wrench 16. The shaft pin 17 is connected to the other end of the elastic frame 11, and the tail end of the elastic frame 11 at this other end abuts against the wrench 16, so as to apply a force to the upper end of the wrench in a direction toward the slurry outlet 100. Under the action of this force, the slurry outlet 100 is kept in a closed state by the cover plate 14-1. The top of the wrench 16 is bent in a direction toward the slurry outlet 100.

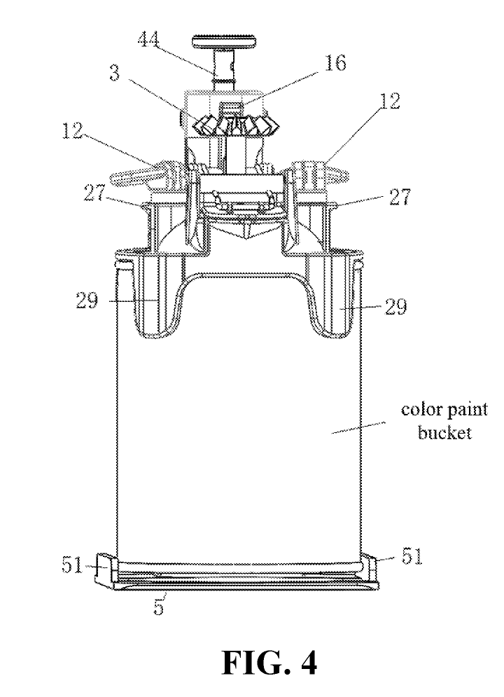

As shown in FIG. 1, FIG. 4, FIG. 6, FIG. 7, and FIG. 8, in order to better adapt to an automatic color mixing device, the color mixing device according to an embodiment of the present disclosure can be detachably positioned and snapped to the automatic color mixing device. Therefore, correspondingly, the device can further include a color masterbatch bucket bracket base plate 5, which is provided with a structure that is interconnected and cooperates with the automatic color mixing device.

In the embodiment, the connecting and mating structure is two upwardly extending lug plates 51. However, the structure is not limited thereto. The connecting and mating structure can vary, and it only needs to achieve the effect of detachably positioning and snapping the present device on the automatic color mixing device. In the embodiment, the masterbatch bucket bracket base plate 5 and the pump bracket 42 are assembled into an integral structure by screws. A space passage 52 for the entry and exit of the color paint raw material bucket is to be provided below the slurry cover body. In the embodiment, in order to ensure the structural support strength of the masterbatch bucket bracket base plate 5, and to minimize the volume of the device, a circular hole is provided in the masterbatch bucket bracket base plate 5 below the slurry cover body as the space passage 52. Of course, the space passage 52 can also have other shapes, and it only needs to allow the color paint raw material bucket to pass vertically, be sleeved on the stirring square column 35 and the blades 352, and be connected to the pressing mechanism 2.

In an embodiment, a breathing valve can further be arranged on the slurry cover body. When the slurry cover body is in a sealing state, the setting of the breathing valve can make the volumetric metering pump operate more smoothly and accurately. Under normal circumstances, when the breathing valve is closed, it can prevent air from entering and also stop the deterioration of the color paste, thereby avoiding changes in the quality of the color paste and inaccurate measurement. The breathing valve can be two check valves in opposite directions. One check valve is inward, and the other is outward. When the volumetric metering pump draws the color paste from the color paint raw material bucket, air is introduced into the color paint raw material bucket through the check valve. When the volumetric metering pump returns the color paste into the color paint raw material bucket, the air is discharged through the outward check valve. In this way, the air pressure inside the bucket is balanced, making it easy to absorb the color paste.

### INDUSTRIAL APPLICABILITY

According to the color mixing device provided by the present disclosure, the color mixing device is communicated with the injection mechanism through the injection path. When the color mixing device is in the working state, the color mixing device can be directly mounted to the color paint raw material bucket, thereby ensuring that the color paste is transported from the injection path to the injection mechanism and then discharged, without the need to transfer the color paste in the color paint raw material bucket to another specially designed container. Therefore, the process steps of color mixing and the device used are simplified.

1. A color mixing device, wherein the color mixing device comprises:
a cover member, wherein the cover member comprises a first side part and a second side part opposite to each other, and the first side part is configured to face a color paint raw material bucket to cover the color paint raw material bucket;
an injection path, wherein the injection path comprises a first path extending from the first side part in a direction away from the cover member and a second path extending along the first side part; and
an injection mechanism, wherein the injection mechanism is connected to the cover member, and the injection mechanism is in communication with the second path.

2. The color mixing device according to claim 1, wherein the color mixing device further comprises a stirring mechanism; the stirring mechanism comprises a rotating assembly; the rotating assembly is sleeved on an outer side of the first path; and the rotating assembly is able to rotate around the first path to stir materials in the color paint raw material bucket.

3. The color mixing device according to claim 1, wherein the color mixing device further comprises a stirring mechanism; the stirring mechanism is connected to the cover member; and the stirring mechanism is configured to stir materials in the color paint raw material bucket; and
the stirring mechanism comprises a driving assembly and a rotating assembly; the rotating assembly is configured to stir the materials in the color paint raw material bucket; the driving assembly passes through the second path; and the driving assembly is in transmission connection with the rotating assembly.

4. The color mixing device according to claim 3, wherein the injection path further comprises a third path; the first path, the second path, and the third path are sequentially communicated; the third path is configured to be located on an outer side of the color paint raw material bucket when the cover member is covered on the color paint raw material bucket, and the injection mechanism is communicated with the second path via the third path; and
the driving assembly comprises a driving shaft and a driving gear passing through the second path; the rotating assembly comprises a rotating body capable of rotating around the first path; and the driving gear is in a transmission connection with the rotating body.

5. The color mixing device according to claim 1, wherein the color mixing device further comprises a stirring mechanism connected to the cover member, and the stirring mechanism further comprises a rotating assembly configured to stir materials in the color paint raw material bucket;
the rotating assembly comprises a rotating body and multiple blades located at an outer side of the rotating body, and the rotating body is able to rotate around the first path; and
the rotating body has multiple side surfaces distributed sequentially in a circumferential direction.

6. The color mixing device according to claim 1, wherein the color mixing device further comprises a stirring mechanism connected to the cover member, and the stirring mechanism further comprises a rotating assembly configured to stir materials in the color paint raw material bucket; and
the rotating assembly comprises a rotating body; the rotating assembly is able to rotate around the first path; the rotating body has a cavity; and an inner side part of the cavity is arranged at intervals from an outer side part of the first path.

7. The color mixing device according to claim 1, wherein the injection mechanism comprises a pump and a liquid outlet, and the pump extracts materials in the color paint raw material bucket via the injection path and then discharges the materials via the liquid outlet;
the cover member has a slurry outlet; the color mixing device further comprises a cover plate and a wrench in transmission connection with the cover plate; and the wrench swings to drive the cover plate to cover and expose the slurry outlet; and
the wrench and the pump are located on a same side of the cover member.

8. The color mixing device according to claim 1, wherein the color mixing device further comprises at least three clamping jaws in a same extension direction as the first path; and the at least three clamping jaws are connected to the cover member; and
each of the clamping jaws has an inclined surface facing the color paint raw material bucket, and one side of the inclined surface close to the cover member is closer to the color paint raw material bucket than one side of the inclined surface farther from the cover member.

9. The color mixing device according to claim 1, wherein the color mixing device further comprises a pressing mechanism; the pressing mechanism comprises a pressing rod passing through the cover member in an opposite direction of the first side part and the second side part; the pressing mechanism further comprises a cam lifting handle and a cam seat; an upper end of the pressing rod is hinged to the cam lifting handle; and the cam seat is sleeved on an outer side of the pressing rod; and
the cam lifting handle has a cam surface; the cam seat is in contact with the cam surface; the cam seat has a flange; the pressing mechanism further comprises a pressing spring; one end of the pressing spring abuts against the flange; and the other end of the pressing spring applies force to the pressing rod.

10. The color mixing device according to claim 1, wherein the color mixing device further comprises a bracket base plate; the bracket base plate has a space passage passing through the bracket base plate in a direction opposite to each other along the first side part and the second side part; and the space passage is configured for the color paint raw material bucket to pass through.

11. The color mixing device according to claim 10, wherein the injection mechanism comprises a pump and a liquid outlet, and the pump extracts materials in the color paint raw material bucket via the injection path and then discharges the materials via the liquid outlet; and
the color mixing device further comprises a pump bracket, wherein the pump is connected to the pump bracket, and the pump bracket is arranged on the bracket base plate.

12. The color mixing device according to claim 5, wherein the rotating body has a stirring column; the stirring column extends along a first direction; the stirring column rotates around an axis extending along the first direction; the axis passes through the stirring column; and the stirring column has multiple side surfaces arranged sequentially adjacent in the circumferential direction, wherein the stirring column has a cavity.

13. The color mixing device according to claim 12, wherein each of the blades is connected to at least two of the side surfaces.

14. The color mixing device according to claim 12, wherein the stirring column further comprises multiple through holes; each of the side surfaces is provided with at least one through hole; through holes on the adjacent side surfaces are alternately arranged in the first direction; the multiple through holes are all communicated with the cavity; and each of the through holes extends in the first direction.

15. The color mixing device according to claim 12, wherein the stirring mechanism further comprises a driving assembly, the rotating body further comprises a shaft sleeve, and the shaft sleeve is connected to the stirring column; the shaft sleeve is located on one side of the stirring column in the first direction; the shaft sleeve is in transmission connection with the driving assembly; and the driving assembly drives the shaft sleeve and the stirring column to rotate around the axis;
the cavity is in communication with the shaft sleeve; one side of the cavity away from the shaft sleeve is opened; and the cavity and the shaft sleeve jointly provide a path for a color paste to pass through;
one side of the rotating body away from the shaft sleeve has an opening, and the opening is communicated with the cavity; and
the shaft sleeve is detachably connected to the stirring column, or the shaft sleeve is integrally formed with the stirring column.

16. The color mixing device according to claim 1, wherein the cover member comprises a slurry cover body; the slurry cover body is mounted on a color paint bucket; the slurry cover body has a fixing part, an adjustment part, and a slurry outlet communicated with the color paint bucket, wherein the adjustment part is able to slide relative to the fixing part to open or close the slurry outlet; and
the color mixing device further comprises:
the wrench, arranged vertically, wherein one end of the wrench is formed as a mounting part rotatably connected to the fixing part, and the other end of the wrench is formed as a driving part located above the slurry cover body; and
an elastic member, having a connecting part and an elastic part, wherein the elastic part is arranged between the wrench and the fixing part, and the connecting part is respectively connected to the adjustment part and the wrench; and
pressing the driving part causes the wrench to rotate in a direction away from the fixing part and compress the elastic part, the connecting part drives the adjustment part to move in a direction close to the fixing part, so as to open the slurry outlet; and releasing the driving part allows the elastic part to reset, thereby driving the wrench to rotate toward a direction close to the fixing part, so that the connecting part drives the adjustment part to close the slurry outlet.

17. The color mixing device according to claim 16, wherein the wrench is formed as a bar-shaped structure that is angled to a sliding direction of the adjustment part.

18. The color mixing device according to claim 16, wherein a protruding positioning part is formed on a side wall of the wrench; and the elastic part is wound around a circumferential side wall of the positioning part, and one end of the elastic part away from the connecting part abuts against the fixing part.

19. The color mixing device according to claim 16, further comprising:
a pump body, communicated with an interior of the color paint bucket and arranged on an outer side of the color paint bucket, wherein the pump body is arranged on one side of the fixing part away from the adjustment part, so that the driving part is able to move in a direction close to or away from the pump body when the wrench rotates; and
at least part of the pump body is located above the slurry cover body to form a handle, and the handle and the driving part are arranged at intervals in a sliding direction of the adjustment part.

20. The color mixing device according to claim 5, wherein the cover member comprises a slurry cover body, and a mounting chamber is formed inside the slurry cover body; and
the color mixing device further comprises:
a first transmission member, wherein one end of the first transmission member is able to extend into the color paint bucket and connect to the rotating body, and the other end of the first transmission member is provided with a first gear; and
a second transmission member, wherein the second transmission member is arranged non-coaxially with the first transmission member; one end of the second transmission member is provided with a second gear engaged with the first gear; the first gear and the second gear are arranged in the mounting chamber; the other end of the second transmission member is formed as a driving end extending outside the slurry cover body; and the driving end is connected to a power device that drives the rotating body to rotate.

21. The color mixing device according to claim 20, wherein the driving end is a bevel gear; the first gear and the second gear are cylindrical gears; an axis of the first transmission member is collinear with a center axis of the color paint bucket; and the first transmission member and the second transmission member are arranged parallel to each other.
